(19) United States
(12) Patent Application Publication
(10) Pub. No.: US 2026/0238097 A1
(43) Pub. Date: Aug. 13, 2026

(54) BENDING DEVICE FOR PRODUCING A WINDING MAT FOR A ROTOR OR A STATOR OF AN ELECTRIC MACHINE

(71) Applicant: ZF FRIEDRICHSHAFEN AG, Friedrichshafen (DE)

(72) Inventors: Matthias EBERT, Himmelstadt (DE); Alexander SCHEUPLEIN, Hohenroth (DE); Ralf SCHNEIDER, Werneck (DE); Martin MAIß, Schwebheim (DE)

(21) Appl. No.: 19/156,094

(22) PCT Filed: Feb. 7, 2024
(86) PCT No.: PCT/EP2024/053005

§ 371 Date: Aug. 13, 2025

(30) Foreign Application Priority Data
Feb. 16, 2023 (DE) 10 2023 201 316.9

(51) Int. Cl. H02K 15/0421; B21C 37/04

(52) U.S. Cl. CPC H02K 15/0421; B21C 37/04

(57) ABSTRACT

A bending device for producing a winding mat for a rotor or stator of an electric machine, having a coil magazine with wire coils fitted in each instance with conductors; a bending unit with rod-shaped wire guides in which a conductor is guided in each instance, at least two bending heads for forming winding heads at the conductors, and at least two bending jaws for stamping layer steps in the conductors; and a transport system with spindles and a conveying unit for transporting the conductors that are bent to form a winding mat, the bending device being operable in a cycle. The coil magazine is a paternoster magazine and the bending unit includes a paternoster guide in which the wire guides are guided, and a concurrent paternoster movement of the wire coils and wire guides in the paternoster magazine and paternoster guide is adjustable.

### CROSS REFERENCE TO RELATED APPLICATIONS

This is a U.S. national stage of Application No. PCT/EP2024/053005 filed Feb. 7, 2024. Priority is claimed on German Application No. DE 10 2023 201 316.9 filed Feb. 16, 2023, the contents of which are incorporated herein by reference.

### BACKGROUND OF THE INVENTION

### 1. Field of the Invention

The disclosure is directed to a bending device for producing a winding mat for a rotor or a stator of an electric machine, which bending device comprises a coil magazine with a plurality of wire coils fitted in each instance with a plurality of conductors; a bending unit with rod-shaped wire guides in which a conductor is guided in each instance, at least two bending heads for forming winding heads at the conductors, and at least two bending jaws for stamping layer steps in the conductors; and a transport system with a plurality of spindles and a conveying unit for transporting the conductors that are bent to form a winding mat, the bending device being operable in a cycle.

### 2. Description of the Related Art

The importance of electric motors has increased dramatically over the course of the transition to environmentally friendly energy and environmentally friendly mobility due to the rising demand for drives which are not dependent on fossil fuels. A conventional electric motor comprises a stator and a rotor. When current flows through the conductors wound around the rotor, a north pole and a south pole are formed and the rotor begins to rotate due to the external magnetic field of the stator. The type of winding for the stator and rotor plays an important role for the efficiency of the electric motor.

During the production of a winding mat for a stator or a rotor, the wave conductors are bent in a U shape and a winding mat is formed by twisting the wave conductors in the turn region. In so doing, the conductors are sometimes highly mechanically stressed. In order to ensure a high efficiency, very smooth running, a low noise level and high robustness of the electric motor, the twisting process must be robust and reproducible, must permit excellent design flexibility and must reduce the spatial area occupied by the winding heads.

The conductor strands must be wound first before being twisted. There are various methods for winding the conductor strands. For example, one or more winding wires or conductors, which can be round wires or flat wires, are fed via a feed device to a winding blade or a plug-in board and wound around the latter.

A method and a device for producing a distributed wave winding for electric motors, particularly those with a high pole number, are known from DE 197 39 353 A1. In the disclosed method, a coil group which comprises a plurality of wires or conductors and is associated with a first phase is produced in a wave-shaped manner on a rotatable template and transferred to an axially aligned coil receiver. The coil group is ejected for this purpose. A further coil group of the same phase with a switching connection to the previous coil group is subsequently wound and transferred to the same coil receiver. By the method, a plurality of wires can be processed in parallel without the individual wires intersecting.

Such methods have the disadvantage that high, wide winding heads are often formed, and the quantity of phase jumps within a winding is routinely limited so that asymmetrically distributed conductor windings may result.

### SUMMARY OF THE INVENTION

It is an object of one aspect of the invention to provide a bending device which allows winding mats to be produced with more compact winding heads and the process to be managed in a precise manner.

The bending device described above includes a coil magazine that is a paternoster magazine and the bending unit comprises a paternoster guide in which the wire guides are guided, and a concurrent paternoster movement of the wire coils and wire guides in the paternoster magazine and paternoster guide is adjustable. A concurrent paternoster movement is characterized in that the wire coils and wire guides are moved in the paternoster magazine and paternoster guide in the manner of a paternoster lift. It is concurrent whenever the conductors between the paternoster magazine and the paternoster guide at no time contact one another. The paternoster movement can be carried out in horizontal orientation as well as in vertical orientation. Critically, there are two paths on which the wire coil and the associated wire guide move jointly in opposing direction and between which, at the end of the respective path, the wire coil and the associated wire guide change from one path to the other in that the paths directly transition into one another, or the wire coil and the associated wire guide are transferred from one path to the other path. Accordingly, in an extreme case, a circular path is viewed as a paternoster movement. In another extreme case, exclusively movements oriented at right angles to one another take place.

In an advantageous configuration, the conductors define two even planes between the paternoster magazine and the bending unit. Therefore, the paternoster movement also takes place in these planes, and the wire coils and the respective associated wire guides alternate between the planes. This configuration simplifies construction and reduces the friction occurring in the system. It is also advantageous when the wire guides and the wire coils are aligned with one another such that the conductors enter the wire guides without kinking. To this end, the rod-shaped wire guides are oriented parallel to the respective conductors guided therein. In this way, friction in the system is further reduced.

The paternoster guide preferably has two worm shaft pairs at which the wire guides are guided and which are arranged parallel to one another and comprise, in each instance, a first worm shaft and a second worm shaft. This allows a very precise guidance of the wire guides in the paternoster guide so that the winding mat to be produced in the bending device can be manufactured in a more precise manner and with greater repeatability.

In this regard, it is particularly advantageous when a straight rail is arranged between the first worm shaft and second worm shaft of the two worm shaft pairs parallel to the first worm shaft and second worm shaft, and the wire guides are rotatably and displaceably supported in the rails. Accordingly, the wire guides are held at at least three points, namely, at the first worm shaft, at the second worm shaft and at the rail, respectively. This improves the functioning of the paternoster guide because it facilitates the transfer of the wire guides between the worm shaft pairs in that a wire guide to be transferred is inserted into the corresponding rail and can subsequently be received by the worm drive pair.

Alternatively or additionally, it is particularly advantageous when the first worm shaft and second worm shaft of each worm shaft pair have a different pitch and/or are rotatable at a different rotational speed. In this way, every wire guide held inside of a worm shaft pair can be adjusted such that the conductors guided inside of a worm shaft pair are radially oriented to a common intersection point.

It is also particularly preferable when the paternoster guide has a transfer unit for transferring the wire guides between the worm shaft pairs. In this way, the operation of the paternoster guide is even more precise, and the repeatability of the production process for the winding mat is further improved. Any suitable transporting unit, such as one or more movable grippers, slides or the like, is contemplated as transfer unit.

Further, an advantageous solution has resulted when the paternoster magazine and the bending unit are fixedly connected via a spacer. This allows all of the components of the bending device, i.e., the paternoster magazine and the bending unit with paternoster guide, to be optimally adapted to one another by the permanently fixed spacing from one another and to optimally adjust the production process for the winding mat.

Alternatively, it is preferable when individual wire coils with the respective associated wire guide are temporarily removable from the paternoster movement within the paternoster magazine and paternoster guide. Such a parking of the corresponding conductor makes it possible to produce more complex winding patterns.

In a further advantageous configuration, it is provided that at least one further conductor in each instance is guided in each of the wire guides. Accordingly, the winding process can be accelerated, since the wires guided in a wire guide are saved simultaneously. To this end, the rest of the components of the bending unit and the transport system are to be configured accordingly.

It is also preferable when a tension acting on the conductors is variable via the wire coil corresponding to the respective conductor. In this way, the tensile force acting on the conductor can be adapted depending on the method step. Further, it is possible to compensate changes in length of the conductors that can occur during the paternoster movement.

In this regard, it is viewed as particularly advantageous when every wire coil has a drive in each instance so that the tension is variable via a torque inducible in the drive. To this end, every wire coil is either connected to a drive or is itself formed as rotor of an electric motor. The torque can then be adapted via a direct power supply of the drives. It is highly preferable that an inductive fast charging system is utilized together with an electric storage provided at the respective wire coil, which inductive fast charging system supplies each wire coil so that the tension is adjustable by a corresponding control unit.

Alternatively or additionally, it is advantageous when a running direction of the paternoster movement is reversible so that the winding pattern of the winding mat that can be produced by the bending device can be more freely adapted.

It is preferable when the bending device described above carries out a method for forming a winding mat for a rotor or stator of an electric machine, comprising the following steps:
A. bending a conductor by a first bending head;
B. simultaneously guiding the conductor in direction of the second bending jaws opposite the first bending head, while first bending jaws located on the side of the first bending head fix the conductor;
C. receiving the conductor by a wire receptacle and at least one spindle. In this regard, a paternoster magazine with wire coils executes a paternoster movement during method step B, and a wire guide located at the conductor is moved from a first worm shaft pair of a paternoster guide to a second worm shaft pair of the paternoster guide and is received at the latter.

A winding mat for a rotor or a stator which is produced by the above-described bending device and a vehicle with an electric machine whose rotor or stator has such a winding mat are also advantageous.

It will be understood that the features mentioned above and those yet to be explained below may be used not only in the stated combinations but also in other combinations or alone without departing from the scope of the present invention.

### BRIEF DESCRIPTION OF THE DRAWINGS

The invention will be explained in more detail in the following by examples with reference to the accompanying drawings which also disclose key features of the invention. These embodiment examples are provided merely to be illustrative and should not be considered as restrictive. For example, a description of an embodiment example having a plurality of elements or components should not be interpreted to mean that all of these elements or components are necessary for its implementation. On the contrary, other embodiment examples may also contain alternative elements and components, fewer elements or components, or additional elements or components. Elements or components of different embodiment examples can be combined with one another unless otherwise stated. Modifications and alterations which are described for one of the embodiment examples may also be applicable to other embodiment examples. Like or comparable elements in the various figures are designated by the same reference numerals and not mentioned repeatedly so as to avoid repetition. The drawings show:

FIG. 1 is a bending device;

FIG. 2 is a side of a paternoster guide such as is used in the bending device;

FIG. 3 is a schematic depiction of a paternoster movement;

FIG. 4 is a portion of a bending unit of the bending device viewed from the direction of the paternoster guide;

FIGS. 5A, 5B a detail view of the stamping of the winding heads; and

FIG. 6 a detail view of a wire coil at a paternoster magazine.

### DETAILED DESCRIPTION OF THE PRESENTLY PREFERRED EMBODIMENTS

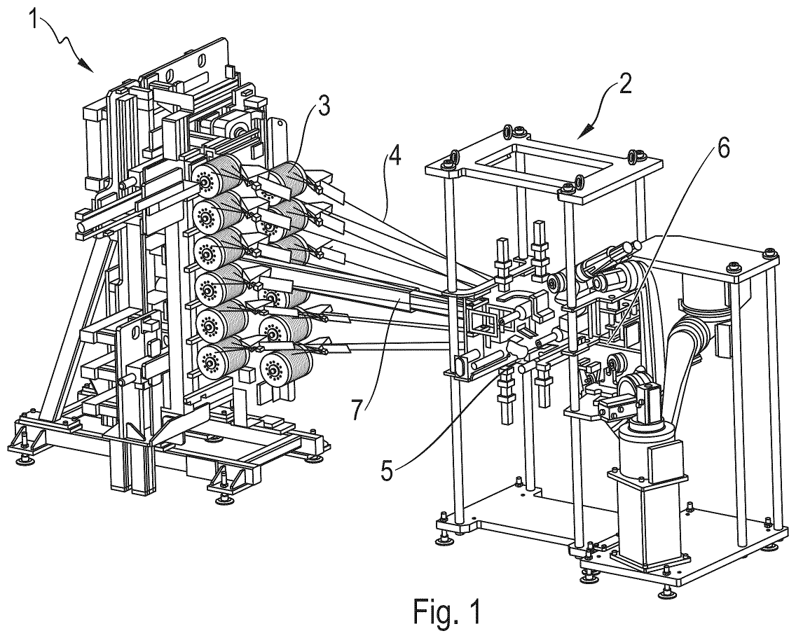

A bending device for producing a winding mat for a rotor or a stator of an electric machine is shown in FIG. 1 and comprises a coil magazine, which is formed as a paternoster magazine 1, and a bending unit 2. The paternoster magazine 1 contains a plurality of wire coils 3 which are each fitted with a plurality of conductors 4 which run from the paternoster magazine 1 to the bending unit 2 in such a way that they define two even planes. The bending unit 2 comprises a bending system and a transport system 6, the bending system comprising, in turn, a paternoster guide 5 and various tools, to be described more fully later, for bending the conductors 4. The paternoster magazine 1 and bending unit 2 are connected via a spacer 7, which is adjustable in length and operate in a common cycle.

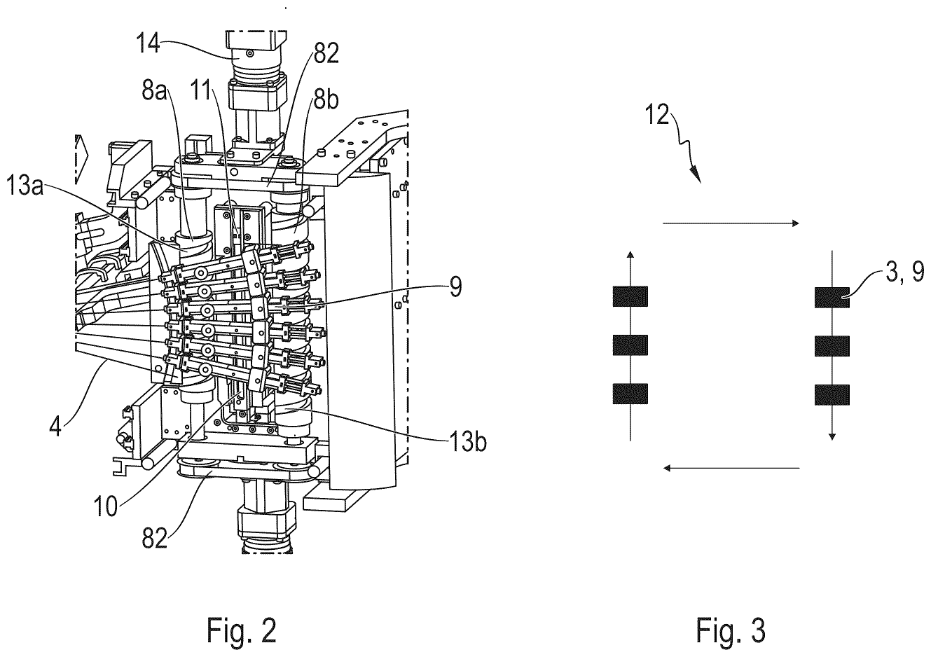

The paternoster guide 5 comprises two worm shaft pairs, one of which is shown in FIG. 2, which are arranged parallel to one another. Each worm shaft pair has a first worm shaft 8a and a second worm shaft 8b which hold a rod-shaped wire guide 9 in the paternoster guide 5 for each conductor 4 guided at the worm shaft pair such that the wire guides 9 are guided at one of the worm shaft pairs in each instance. Further, a straight rail 10 is arranged between the first worm shaft 8a and second worm shaft 8b, the wire guides 9 being rotatably and displaceably held and supported at the straight rail 10 so that the latter are held at at least three points. The rail 10 extends parallel to the worm shafts 8a, 8b. Alternatively, it is also possible that a plurality of conductors 4 are guided together per wire guide 9. The construction of the bending device accordingly changes only in such a way that the other components must also be adapted to a plurality of conductors 4 per wire guide 9.

The worm shaft pairs are described in more detail in the following. These worm shaft pairs are constructed such that a first worm shaft pair moves the wire guides 9 in a first direction, while the second worm shaft pair moves the wire guides 9 in a second direction opposite the first direction. To this end, threads located at the worm shafts 8a, 8b, or the rotational direction thereof, are adapted to one another. When a wire guide 9 is transported along a worm shaft pair, it is transferred by a transfer unit 11 to the other worm shaft pair so that it is transported in a continuously alternating manner along the worm shaft pairs. This movement corresponds to the paternoster movement 12 as is shown schematically in FIG. 3 for wire coils 3 and wire guides 9. The running direction of the paternoster movement 12 is indicated by the arrows and can easily be reversed.

The first worm shaft 8a and second worm shaft 8b of each worm shaft pair have different pitches 13b, 13b so that the wire guides 9 are transported along the worm shaft pair at different speeds. This results in a tilting motion of the wire guides 9 which causes the conductors to be oriented to a common intersection point and radially away from the latter. The conductors 4 are preferably held in such a way that they are at an acute angle relative to one another.

The first worm shaft 8a and the second worm shaft 8b of each worm shaft pair are moved by a motor 14 in that the motor 14 drives both worm shaft pairs in that it is coupled in each instance by a belt drive 82 at each side of the worm shaft pair. It is also possible, but not shown, to drive the first worm shaft 8a directly and to transmit the rotational movement from the first worm shaft 8a to the second worm shaft 8b by a belt drive 82 in each instance at both sides of the worm shafts 8a, 8b.

In general, the different speeds can also be achieved via a different rotational speed of the first worm shaft 8a and second worm shaft 8b. For this purpose, either a motor 14 would have to be provided for each worm shaft 8a, 8b or a fixed transmission is implemented.

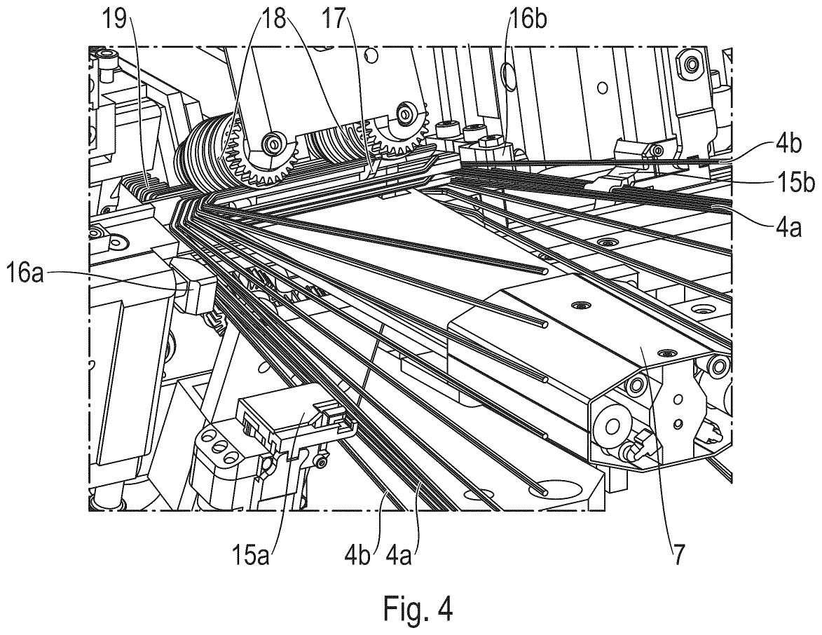

FIG. 4 shows a portion of the bending unit 2 from the viewing direction of the paternoster guide 5. In the depicted portion of the bending unit 2, the conductors 4 are bent to form a winding mat. The paternoster movement 12 is carried out in such a way that the conductors 4 are transported upward on the right-hand side of FIG. 4 and downward on the left-hand side. The conductors 4 are shaped in a bending plane in each instance during the transport by bending heads 15a, 15b and bending jaws 16a, 16b.

The bending process will be described referring to one of the conductors 4a. First bending jaws 16a are advanced to the conductor 4a in the region of a first winding head and fix the conductor 4a. A first bending head 15a which is movable in all spatial axes simultaneously or subsequently shapes a first portion of a second winding head. In so doing, it receives the conductor 4a to be bent and guides it to the opposite side, where it is transferred from a wire receptacle 17 to spindles 18 arranged in pairs and a conveying unit 19. Together with the wire coils 3 in the paternoster magazine 1 and the transfer unit 11 at the paternoster guide 5, the transfer of the conductor 4a along with the corresponding wire guide 9 takes place from one worm shaft pair to the other. On the opposite side, the conductor 4a is received and shaped by the second bending jaws 16b after reaching the bending plane so that a second portion of the second winding head, and therefore the second winding head in its entirety, is given its final shape.

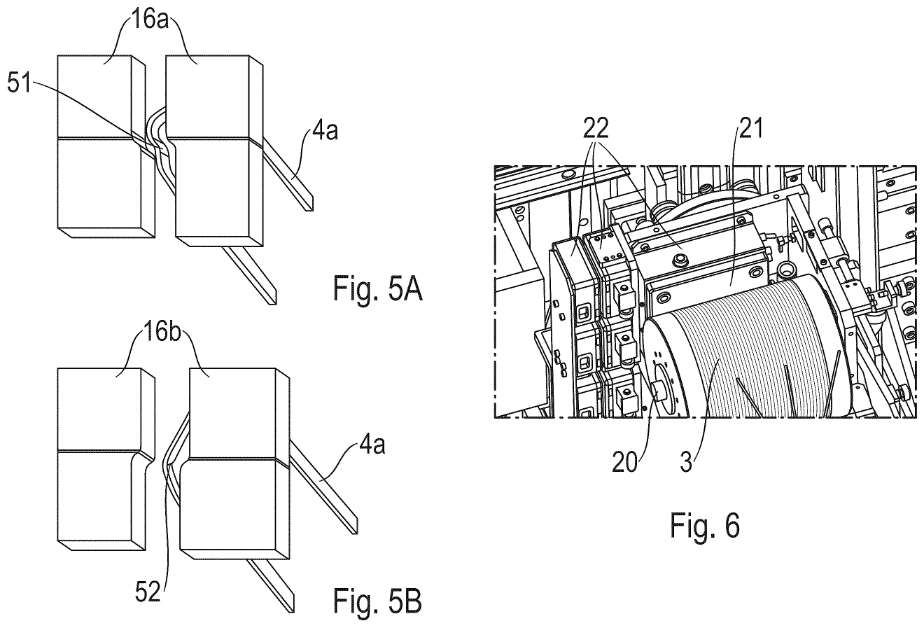

Additionally, a stamping of a layer step takes place by the bending jaws 16a, 16b as is shown in FIGS. 5a and 5b. The stamping of a first layer step 51 and of a second layer step 52, respectively, in a gable-shaped portion of a winding head in each instance is shown in detail. The layer steps 51, 52 describe a step of a conductor 4 corresponding to a radial offset between two adjacent webs of the winding mat in the finished rotor or stator. The stamping can advantageously ensure additionally that the thickness of the conductor 4 decreases. The stamping makes it possible to twist a plurality of conductors 4 together to form the winding mat. Depending on the construction, one or more conductors 4 are provided with a layer step simultaneously by the bending jaws 16a, 16b.

Referring to FIG. 4, a parked conductor 4b is located below the first bending head 15a and above the second bending head 15b outside of the bending plane. The parked conductors 4b are removed from the paternoster movement 12 inside of the paternoster magazine 1 and paternoster guide 5. This can be accomplished in that the respective parked conductor 4b is transported past the bending jaws 16a, 16b instead of being bent, so that it reaches a parked position. In this regard, the parked conductors 4b can either be entirely removed from the paternoster magazine 1 and paternoster guide or via a parking mechanism, such as, e.g., the transferring of an individual wire guide 9 at separately drivable or further worm shafts that are decouplable from the worm shafts 8a, 8b in combination with a parking zone correspondingly provided at the paternoster magazine 1.

By such a method, the winding mat is formed so as to be adapted to the desired winding pattern, transported to a tool carrier, not shown, by the conveying unit 19 and transferred over to the tool carrier.

As a result of the radial arrangement of the conductors 4, every conductor changes the distance from the bending unit 2 depending on the position at the paternoster magazine 1, since the paternoster movement 12 in the paternoster magazine 1 is carried out in an even plane. A defined length of the conductor 4 must also be released from the wire coil 3 during the transfer of a wire guide 9 between the worm shaft pairs in order to allow the bending by the bending heads 15a, 15b. In order to compensate for the differences in the tension acting on the conductors 4 as a direct consequence thereof depending on the position at the paternoster magazine 1, the wire coils 3 are formed as shown in FIG. 6. The depicted wire coil 3 has a drive 20 so that the tension is variable via a torque inducible in the drive 20. The drive 20 is connected to electronics 21 that comprise an electric storage for supplying the drive 20 with current and a control unit and carries out the paternoster movement 12 together with the wire coil 3. The electric storage can be recharged, for example, with an inductive fast charging system 22, during each pass so that the production process for the winding mat need not be interrupted. The control unit of the electronics 21 controls the drive 20 so that the tension acting on the respective conductor 4 is exactly adapted to the current work step.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-15. (canceled)

16. A bending device configured to produce a winding mat for a rotor or a stator of an electric machine, comprising:
a coil magazine that is a paternoster magazine with a plurality of wire coils each fitted with a plurality of conductors;
a bending unit comprising:
rod-shaped wire guides in which a respective conductor is guided in each instance;
a paternoster guide in which the wire guides are guided;
at least two bending heads configured to form winding heads at the plurality of conductors; and
at least two bending jaws configured to stamp layer steps in the plurality of conductors; and
a transport system with a plurality of spindles and a conveying unit for transporting the plurality of conductors that are bent to form a winding mat,
wherein the bending device is operable in a cycle,
wherein a concurrent paternoster movement of the wire coils and wire guides in the paternoster magazine and paternoster guide is adjustable.

17. The bending device according to claim 16, wherein the plurality of conductors define two even planes between the paternoster magazine and the bending unit.

18. The bending device according to claim 16, wherein the paternoster guide has two worm shaft pairs at which the wire guides are guided and which are arranged parallel to one another and comprise, in each instance, a first worm shaft and a second worm shaft.

19. The bending device according to claim 18, wherein a straight rail is arranged between the first worm shaft and second worm shaft of the two worm shaft pairs parallel to the first worm shaft and second worm shaft, and the wire guides are rotatably and displaceably supported in the straight rails.

20. The bending device according to claim 18, wherein the first worm shaft and second worm shaft of each worm shaft pair have a different pitch and/or are rotatable at a different rotational speed.

21. The bending device according to claim 18, wherein the paternoster guide has a transfer unit configured to transfer the wire guides between the worm shaft pairs.

22. The bending device according to claim 16, wherein the paternoster magazine and the bending unit are fixedly connected via a spacer.

23. The bending device according to claim 16, wherein individual wire coils with a respective associated wire guide are temporarily removable from the paternoster movement within the paternoster magazine and paternoster guide.

24. The bending device according to claim 16, wherein at least one further conductor in each instance is guided in each of the wire guides.

25. The bending device according to claim 16, wherein a tension acting on the plurality of conductors is variable via the wire coil corresponding to each respective conductor.

26. The bending device according to claim 25, wherein every wire coil has a drive so that the tension is variable via a torque inducible in the drive.

27. The bending device according to claim 16, wherein a running direction of the paternoster movement is reversible.

28. A method for forming a winding mat for a rotor or stator of an electric machine by a bending device having a coil magazine that is a paternoster magazine with a plurality of wire coils each fitted with a plurality of conductors; a bending unit comprising: rod-shaped wire guides in which a respective conductor is guided in each instance; a paternoster guide in which the wire guides are guided; at least two bending heads configured to form winding heads at the plurality of conductors; and at least two bending jaws configured to stamp layer steps in the plurality of conductors; and a transport system with a plurality of spindles and a conveying unit for transporting the plurality of conductors that are bent to form a winding mat, wherein the bending device is operable in a cycle, wherein a concurrent paternoster movement of the wire coils and wire guides in the paternoster magazine and paternoster guide is adjustable, the method comprising:
A. bending a respective conductor by a first bending head;
B. simultaneously guiding the respective conductor in direction of a second bending jaws opposite the first bending head, while first bending jaws located on a side of the first bending head fix the conductor; and
C. receiving the conductor by a wire receptacle and at least one spindle,
wherein the paternoster magazine with wire coils executes the paternoster movement during method step B, and the wire guide located at the conductor is moved from a first worm shaft pair of a paternoster guide to a second worm shaft pair of the paternoster guide and is received at the latter.
